(19) United States
(12) Patent Application Publication
(10) Pub. No.: US 2008/0252085 A1
(43) Pub. Date: Oct. 16, 2008

(54) Adjustable Strike

(75) Inventors: Alfred L. Langtry, Pittsburgh, PA (US); Jeffrey A. Yonkey, Greensburg, PA (US); Robert J. Roach, Mars, PA (US)

Correspondence Address: Beck & Thomas, P.C.;SUITE 100, 1575 McFARLAND ROAD, PITTSBURGH, PA, 15216-1808, US

(73) Assignee: ERVOS, INC., Pittsburgh, PA (US)

(21) Appl. No.: 12/101,681

(22) Filed: Apr. 11, 2008

Related U.S. Application Data
(60) Provisional application No. 60/911,668, filed on Apr. 13, 2007.

(51) Int. Cl. E05B 15/02

(52) U.S. Cl. 292/340

(57) ABSTRACT

This invention is for an adjustable strike. The adjustable strike is a strike plate having a hole to receive a latch bolt. There is an adjustment piece that adjusts the size of the hole so that the latch bolt will latch properly.

### CROSS-REFERENCE TO RELATED APPLICATIONS

This application claims the benefit of U.S. Provisional Application No. 60/911,668 filed Apr. 13, 2007 which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

(1) Field of the Invention

This invention relates to strike plates used in connection with latch bolts to keep a door closed.

(2) Description of Related Art

Typical strike plates are attached to a door jamb during the installation of a door. The strikes are typically matched to the latch bolt during the installation of the door. The connection of the latch bolt on the door and the strike usually involve tight tolerances and the installer has to be careful to match the strike with the latch bolt to make sure that the latch bolt latches and keeps the door closed. If this is not done properly the door will not latch.

Immediately or over time the normal position of the latch bolt can change. The position of the latch bolt could immediately be a problem if the door is already warped when it is put up. The position of the latch bolt can change because of warped doors, extra thick weather stripping located on the frame stop, and misaligned doors in relation to the frame. Because of the tight tolerances, if the position of the latch bolt changes it will cause the latch bolt not to latch properly and result in a door that does not close properly. Standard ANSI strikes are not adjustable. Therefore in order to fix this problem laborious filing of the door jamb is required to fix and enlarge the strike. If this problem occurred due to warping then when the weather changes and the door straightens then the strike will be too large causing problems with the latch. This will lead to a repair person having to replace the strike.

A strike that attempted to solve that problem is a strike that has serrated pads at the top and bottom of the screw holes on the back side of the strike. These screw holes are used to attach the strike to the door jamb. The concept behind this is that the position of the entire strike is horizontally adjustable. In order for this type of arrangement to work in an ANSI frame cut out one must make the thickness of the strike half as thick to accommodate for the extra thickness of the serrated pads located at the strike screw hole attachment. The resulting thin strike plate is weak and not suitable for commercial and institutional buildings. Additionally, it is not capable of any vertical adjustment.

### BRIEF SUMMARY OF THE INVENTION

This invention provides for an adjustable strike. The adjustable strike is a strike plate having a hole to receive a latch bolt. There is an adjustment piece that adjusts the size of the hole so that the latch bolt will latch properly. The strike plate can have a thickness of at least 0.090 inches. Preferably the strike has a thickness from 0.090 inches to 0.093 inches. The hole for a cylindrical strike can be at least 1.25 inches high and 0.844 inches in wide. The standard width for a cylindrical strike is typically 0.688. It can be increased by 5/32 inches so the total width is 0.844 inches. It could also have a vertical adjustment of ⅛ inch or 1/16 inch on a top and a bottom. This adjustment could be made by having a larger height of the hole of 0.1875 on both the top and bottom giving a total hole height of 1.625 inches for sagging doors or sagging buildings. The cylindrical lock strike standard height of the hole is 1.25 inches.

If the strike is for a mortise type latch the adjustment can be vertical or horizontal. The total width of the standard hole is 0.750 inches. It could have an additional 5/32 inch of a hole. So the hole could be 0.906 inches wide. The height of the hole is 3.0 inches. It could have an additional ⅛ inch to it having a 1/16 inch on each of the top and the bottom.

The adjustment piece can be a sliding plate on the inside of the strike that is attached to the strike fasteners that release and fix the sliding plate into the proper position so that a proper sized hole is created.

The adjustment piece can be a rectangular plate having a C-shaped notched out section in the middle of the rectangular plate. The C-shaped notched out section will surround the hole in the strike so that a width of the hole can be narrowed by moving a vertical portion of the C-shaped channel over an outer vertical edge of the hole and the height of the hole can be adjusted by moving a horizontal portion of the C-shaped channel over an outer horizontal edge of the hole.

The horizontal adjustment of the hole can be 5/32 inches.

This invention also provides for a method for adjusting a strike so that a latch bolt will latch. A strike having a hole for receiving the latch bolt is provided. The size of the hole in the latch bolt is adjusted so that the latch bolt latches. The adjustment of the size of the hole can mechanically be accomplished by providing: (1) a sliding plate on the inside of the strike plate; (2) adjustment slots in the adjustment plate; and (3) fasteners to fit within the adjustment slots. The fasteners are first loosened to allow for free movement of the sliding plate. The plate can then be slid so that it covers part of the hole and thereby adjusting the position hole in the strike to allow for the latch bolt to latch. The fasteners are then tightened to fix the sliding plate in the proper location.

This invention also provides for a method for installing a strike. A strike for a latch bolt having a sliding plate that adjusts the size of the hole within the strike is provided. The strike is fixed to the door jamb. The sliding plate is adjusted so that the door latches properly.

This invention also provides for a method for fixing a door that will not latch because of improper alignment of the latch bolt and the strike. A strike having a hole for a latch bolt wherein the size of the hole is adjustable is provided. The size of the hole is adjusted so that the latch bolt properly latches with the hole in the strike.

### BRIEF DESCRIPTION OF THE SEVERAL VIEWS OF THE DRAWING(S)

FIG. 1 is a front view of the adjustable strike having the adjustment piece extended.

FIG. 2 is a back view of the adjustable strike having a rounded hole.

FIG. 3 is a front view of the adjustable strike having a rectangular hole having the adjustment piece extended.

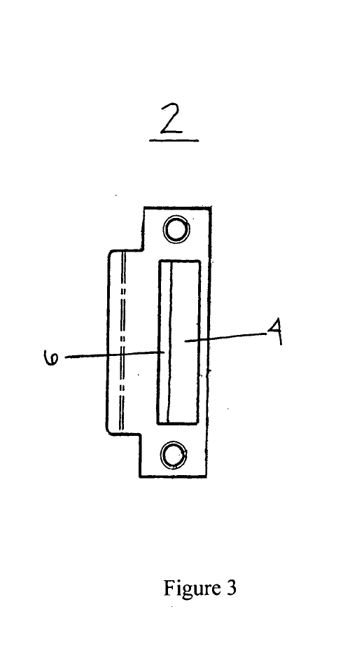

### DETAILED DESCRIPTION OF THE INVENTION

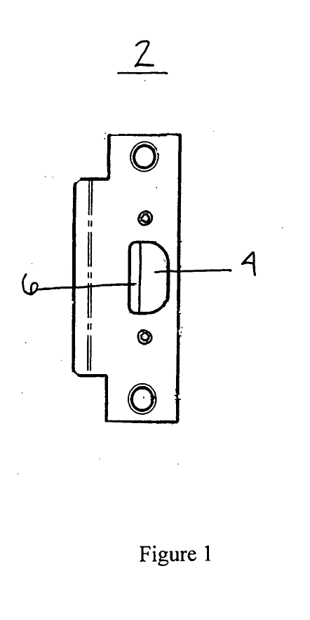

FIG. 1 shows a front view of the strike plate 2 having a hole 4 for receiving a latch bolt. An adjustment piece 6 is in fully extended position. The strike plate 2 is a typical ANSI (ASA) strike. The measurement is typically 4.875 inches in length and 1.250 inches in width without the lip and has an additional 0.625 inch making the strike at its widest point 1.875 inches.

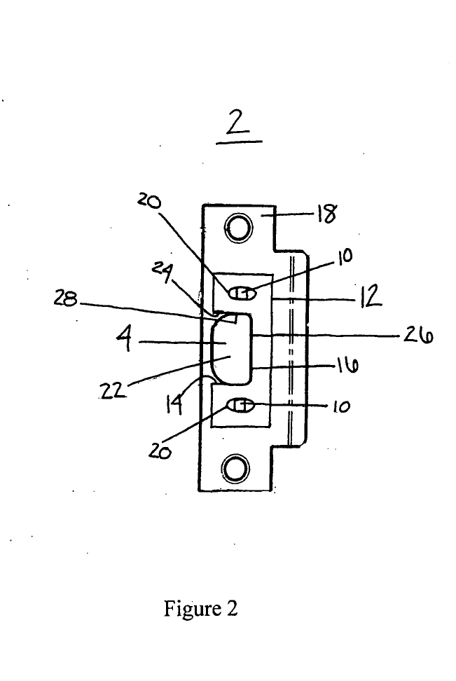

FIG. 2 shows a back view of the strike plate 2 having a hole 4 that is rounded. As seen in this embodiment the adjustment piece is a sliding plate that is a rectangular plate 12. The rectangular plate 12 has a C-shaped notched out section 14. The C-shaped notched out section 14 of the rectangular plate 12 has a vertical portion 16. The rectangular plate 12 is located on the back 18 of the strike plate 2.

Adjustment slots 20 on the rectangular plate 12 are used so that the rectangular plate 12 can slide and move to different positions. The plate does not have to be square it can be at an angle. Fasteners 10 are used to fix the location of the rectangular plate 12. In the preferred embodiment the fasteners are Allen head screws with friction nuts. When the fasteners 10 are loosened rectangular plate 12 can slide around because of the adjustment slots 20. The size of the adjustment slots plays a part in how much the rectangular plate 12 can move and thus the size of the hole 4.

The vertical portion 16 of the C-shaped notched out section 14 can slide over and cover an outer vertical edge 26 of the hole 4. Vertical portion 16 can slide completely out of view giving the maximum opening position 22 as shown in FIG. 2. For vertical adjustment of the strike the horizontal portion 24 of the C-shaped notched out section 14 of the rectangular plate 12 can be slid to either reduce the size of hole 4 by extending over the outer horizontal edge 28 of the hole 4 or it can increase the size of the hole by sliding completely out of view. The preferred way for vertical adjustment is vertical enlargement of the hole.

Typically the strike plate 2 will be installed into an ANSI frame cut out. The fasteners 10 will be loosened and the rectangular plate 12 will be adjusted so that a latch bolt will properly latch within the hole 4. When that occurs the fasteners 10 would be tightened so that the rectangular plate 12 would be fixed and provide a fixed hole size 4. Over time if the door is warped a repair person is sent out. All the repair person will have to do is loosen the fasteners 10 and adjust the rectangular plate 12 so that the latch bolt can once again latch properly and then tighten the fastener 10.

The strike plate is typically 4⅞ inches. The capability of being able to vertically adjust the size of hole 4 is important in situations to correct sagging doors and mismatched doors and frames. These types of conditions are particularly prevalent with mortise lock latches not matching strike locations.

The size of the hole 4 can be readjusted so that it is smaller after it is first adjusted to have an increased size.

Various changes could be made in the above construction and method without departing from the scope of the invention as defined in the claims below. It is intended that all matter contained in the above description, as shown in the accompanying drawings, shall be interpreted as illustrative and not as a limitation.

2—strike plate

4—hole within the strike plate

6—an adjustment piece

10—fasteners

12—rectangular plate

14—C-shaped notched out section

16—vertical portion of the C-shaped notched out section

18—back side of the strike plate

20—adjustment slots

22—maximum opening position

24—horizontal portion of the C-shaped notched out section

26—outer vertical edge

28—outer horizontal edge

We claim:

1. An adjustable strike comprising:
(a) a strike plate;
(b) a hole within the strike plate for receiving a latch bolt; and
(c) an adjustment piece that adjusts the size of the hole so that the latch bolt will latch properly.

2. An adjustable strike as recited in claim 1 wherein the strike plate has a thickness of from 0.090 inches to 0.093 inches.

3. An adjustable strike as recited in claim 1 wherein the strike is a cylindrical strike and the hole at its maximum opening position is at least 1.625 inches high and 0.8442 inches wide.

4. An adjustable strike as recited in clam 1 wherein the adjustment piece comprises:
(a) a sliding plate on the inside of the strike plate; and
(b) a fastener to release and fix the sliding plate in the proper position to obtain a proper sized hole.

5. An adjustable strike as recited in claim 4 wherein the sliding plate comprises:
(a) a rectangular plate; and
(b) a C-shaped notched out section in the middle of the rectangular plate, the C-shaped notched out section surrounds the hole in the strike so that a width of the hole in the strike can be narrowed or expanded by moving a vertical portion of the C-shaped notched out section over an outer vertical edge of the hole in the strike and the height of the hole in the strike can be shortened or lengthened by moving a horizontal portion of the C-shaped notched out section over an outer horizontal edge of the hole in the strike.

6. An adjustable strike as recited in claim 1 wherein the adjustment piece provides at least 1/32″ horizontal adjustment in the size of the hole.

7. A method for adjusting a strike so that a latch bolt will latch comprising:
(a) providing a strike having a hole for receiving the latch bolt; and
(b) adjusting the size of the hole so that the latch bolt latches and allows for readjustment of the size of the hole.

8. A method as recited in claim 7 wherein the adjusting and the readjusting the size of the hole is done by:
(a) providing a sliding plate on the back of the strike plate;
(b) providing an adjustment slot in the sliding plate;
(c) providing a fastener to fit within the adjustment slot;
(d) loosening the fastener to allow for free movement of the sliding plate;
(e) sliding the sliding plate so that it covers part of the hole so that the appropriate size hole is obtained; and
(f) tightening the fastener to fix the sliding plate.

9. A method for installing a strike comprising:
(a) providing a strike for a latch bolt having a sliding plate that adjusts the size of the hole within the strike;
(b) fixing the strike to the door jamb; and
(c) adjusting the sliding plate so that the door latches properly.

10. A method for fixing a door that will not latch because of improper alignment of a latch bolt and a strike comprising:
(a) providing a strike having a hole for a latch bolt wherein the size of the hole is adjustable; and
(b) adjusting the size of the hole so that the latch bolt properly latches with the hole in the strike.

11. A strike as recited in claim 1 wherein the strike is a mortise strike and the maximum opening of the hole is 0.906 inches in width and 3.125 inches in length.

12. A strike as recited in claim 1 wherein the strike has a height of 4.875.
